(19) United States
(12) Patent Application Publication
(10) Pub. No.: US 2009/0319760 A1
(43) Pub. Date: Dec. 24, 2009

(54) SINGLE-CYCLE LOW POWER CPU ARCHITECTURE

(75) Inventors: Benjamin F. Froemming, San Jose, CA (US); Emil Lambrache, Campbell, CA (US)

Correspondence Address: SCHWEGMAN, LUNDBERG & WOESSNER / ATMEL, P.O. BOX 2938, MINNEAPOLIS, MN, 55402, US

(73) Assignee: Atmel Corporation

(21) Appl. No.: 12/549,328

(22) Filed: Aug. 27, 2009

Related U.S. Application Data
(63) Continuation of application No. 11/071,966, filed on Mar. 4, 2005, now abandoned.

(51) Int. Cl. G06F 9/30

(52) U.S. Cl. 712/225; 712/E09.016

(57) ABSTRACT

An n architecture for implementing an instruction pipeline within a CPU comprises an arithmetic logic unit (ALU), an address arithmetic unit (AAU), a program counter (PC), a read-only memory (ROM) coupled to the program counter, to an instruction register, and to an instruction decoder coupled to the arithmetic logic unit. A random access memory (RAM) is coupled to the instruction decoder, to the arithmetic logic unit, and to a RAM address register.

### CONTINUATION APPLICATION

This application is a continuation of U.S. patent application Ser. No. 11/071,966, filed on Mar. 4, 2005, which is incorporated herein by reference in its entirety.

### RELATED ART

This application incorporates by reference, in its entirety, all material found in co-pending U.S. Provisional Application No. 60/658,473 filed Mar. 4, 2005, and having the same inventive entity.

### TECHNICAL FIELD

The present invention is related to integrated circuits. More specifically, the present invention is an apparatus and method for a microcontroller architecture which implements an instruction pipeline to speed program execution and reduce power consumption.

### BACKGROUND ART

Raising the system clock frequency is an often-used method for improving the computational performance of a central processing unit (CPU) within a microprocessor or microcontroller. It is appreciated by those skilled in the art that the typical power (P) consumed by a CPU depends upon the total CPU gate capacitance (C), the power supply voltage (V), and the system clock frequency (f) according to the formula:

P ∝ CV²f

The power consumption can be reduced by lowering C, V, or f. The on-chip capacitance (C) is established by the quantity of gates required to implement a design. Established designs are usually optimized in terms of minimizing the gate count needed to realize the required logic, and typically offer little opportunity for improvement. The operating voltage (V) is limited by process technology and associated operating characteristics of transistors built upon that technology. The system clock frequency (f) often provides the best opportunity for improvement.

By reducing the number of clock cycles required to complete an instruction, the system clock frequency can be lowered to reduce power while maintaining computational throughput. Alternately, the system clock frequency can be maintained and a higher rate of computation can be performed for a given power expenditure. In either case, the energy required per computation is reduced. Thus, reduction of the number of clock cycles needed to execute an instruction is a significant method for improving the performance of a CPU. What is needed, therefore, is a method for realizing a high performance CPU; that is, with high speed and low power consumption, by means of reducing the number of clock cycles required to execute an instruction. A system and method for executing instructions in parallel can meet this requirement by increasing the number of instructions executed with a given quantity of system clock cycles.

### SUMMARY OF THE INVENTION

The present invention is an apparatus and method for an instruction pipeline in a CPU. In an exemplary embodiment, the present invention is incorporated into a microcontroller which operates on the MCS-51 instruction set with 16-bit addresses and 8-bit data. Microcontrollers which utilize the MCS-51 instruction set are known by skilled artisans as 8051 microcontrollers. With reference to FIG. 1, a block diagram of an 8051 microcontroller as known in the prior art has an internal bus providing a common path for communication between a read-only memory (ROM), a random access memory (RAM), and an arithmetic logic unit (ALU). An address register (AR), an accumulator register (ACC), a temporary register (TMP), a data pointer register (DPTR) and a stack pointer register (SP) are each attached to the internal data bus.

The typical 8051 microcontroller known in the prior art requires three system clock cycles to fetch a single byte instruction from read-only memory (ROM) to an instruction register (IR). The present invention reduces the single-byte instruction fetch to a single system clock cycle. The instructions in the MCS51 instruction set are one, two, or three bytes in length. In prior-art 8051 microcontrollers, the instruction fetch operations can therefore require up to nine system clock cycles:

| Instruction Length | Fetch |
|---|---|
| (Bytes) | (System Clocks) |
| One | Three |
| Two | Six |
| Three | Nine |

In prior art 8051 microcontrollers, the time required to complete execution of an instruction exceeds the fetch time because the micro-operations required by the instruction can only be performed after completion of the instruction fetch operation and the micro-operations must timeshare a single internal bus. Typically, instructions require six or twelve system clock cycles to execute. Thus, a one-byte instruction or a two-byte instruction will execute in six system clock cycles, effectively wasting three system clock cycles in the execution of a single-byte instruction. A three-byte instruction will require twelve system clock cycles to execute, effectively wasting three system clock cycles.

In the exemplary embodiment of the present invention, a single cycle per byte fetch is enabled by means of a 16-bit address arithmetic unit (AAU) coupled to a program counter (PC) and a dedicated increment/decrement unit coupled to a stack pointer (SP). The program counter (PC) is continually incremented by a value of “1” with each instruction byte fetched in order to maintain the instruction pipeline, but the stack pointer (SP) can be independently pushed or popped to enable servicing interrupts. A random access memory (RAM) is used to preserve the program counter (PC) value during interrupt servicing and to restore the program counter (PC) value upon return from the interrupt subroutine. A dedicated buffer preserves the correct return address during interrupt or software calls for pushing onto the RAM.

A further improvement over the prior art is implemented by utilizing separate registers to provide random access memory (RAM) read address storage and write address storage. The dedicated RAM write address register makes it possible to defer a write operation associated with an instruction. The deferred write operation enables instructions to effectively complete operation during a given system clock cycle, with the associated write operation occurring in the following system clock cycle. The deferred RAM write capability makes it possible to avoid stalling the instruction pipeline by a pending write operation. The separate RAM read address storage and RAM write address storage registers also enable a data pass-through capability in the RAM: When both registers are provided with the same RAM address, data present in a RAM data storage register is immediately made available on the RAM output, while simultaneously being written to the addressed storage area. The pass-through feature makes it possible for the results of a computation to be available to further processing with minimum time delay, further enabling the capabilities of the instruction pipeline.

An instruction pre-decode path is provided from the read-only memory (ROM) to the random access memory (RAM) which is used to speed execution of register operations, bypassing the normal decode process. In addition a register bank forwarding path prevents the pipeline from stalling when a register operation follows a change of the active register bank in a program status word (PSW).

A dedicated data path is provided from the RAM data output directly to an 8-bit data arithmetic logic unit (ALU) without an intermediate temporary storage register. A dedicated data path is also provided from the arithmetic logic unit (ALU) to the RAM data input register. The dedicated data path features provide a high-throughput path enabling data to be read from the RAM, processed, and subsequently written back to the RAM. This is an improvement over the prior art 8051 microcontrollers that utilize a single internal bus.

The combined improvements embodied by the dedicated data paths, the instruction pre-decode and bank forwarding, and the separate RAM read and write address registers allows a complete a register increment instruction in a single system clock cycle, and a register indirect increment in two system clock cycles.

### BRIEF DESCRIPTION OF THE DRAWINGS

FIG. 1 is a block diagram of an 8051 microcontroller as known in the prior art.

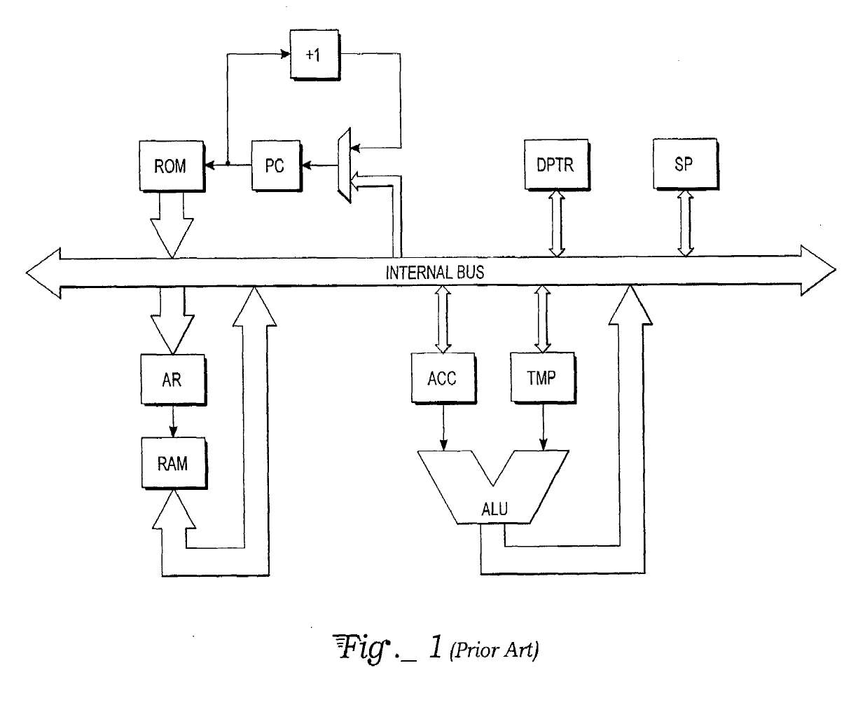

FIG. 2 is an architecture block diagram of a pipeline portion of a CPU according to an exemplary embodiment of the present invention.

FIG. 3 is a timing diagram for instruction pipelining with single-byte instructions in accordance with an exemplary embodiment of the present invention.

FIG. 4 is a timing diagram for instruction pipelining with single-byte and two-byte instructions in accordance with an exemplary embodiment of the present invention.

FIG. 5 is a diagram of activity within an arithmetic logic unit (ALU) when executing single-cycle instructions in accordance with an exemplary embodiment of the present invention.

FIG. 6 is a diagram of activity within an arithmetic logic unit (ALU) when executing two-cycle instructions in accordance with an exemplary embodiment of the present invention.

FIG. 7 is an exemplary architecture block diagram of an address computation portion of a CPU according to the present invention.

FIG. 8A is an illustration of address buffer utilization in accordance with an exemplary embodiment of the present invention during regular instruction execution.

FIG. 8B is an illustration of address buffer utilization in accordance with an exemplary embodiment of the present invention during a hardware interrupt execution.

FIG. 8C is an illustration of address buffer utilization in accordance with an exemplary embodiment of the present invention during a software interrupt execution.

FIG. 9 is an exemplary architecture block diagram of an instruction pre-decode and RAM access portion of a CPU according to the present invention.

FIG. 10 is a timing diagram for a register increment instruction in accordance with an exemplary embodiment of the present invention.

### DETAILED DESCRIPTION OF THE INVENTION

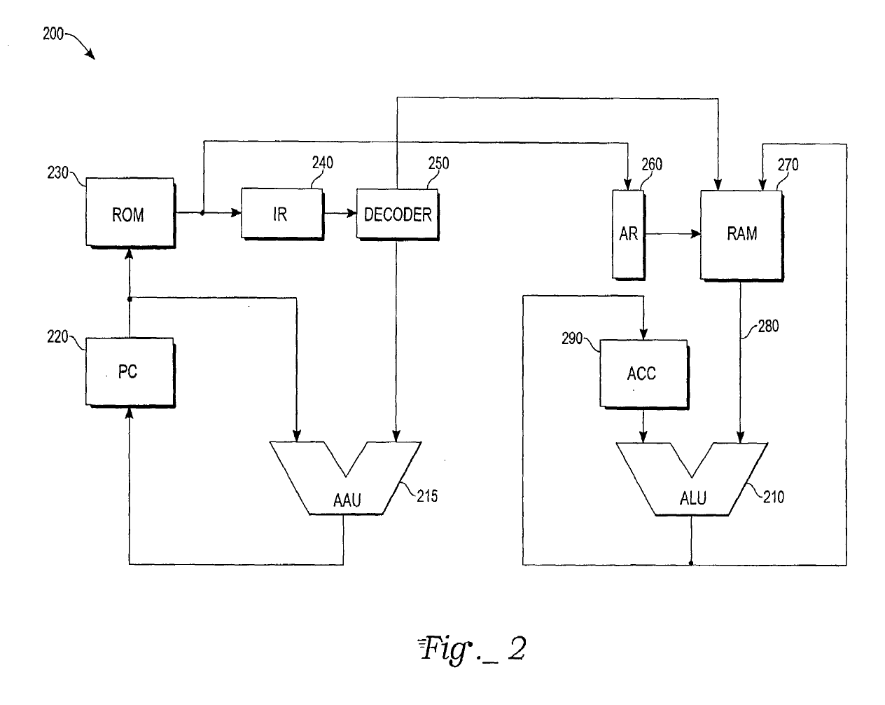

With reference to FIG. 2, a central processing unit (CPU) pipeline architecture portion 200 according to an exemplary embodiment of the present invention comprises an arithmetic logic unit (ALU) 210 having a first data input, a second data input, and a data output. In the exemplary embodiment, the arithmetic logic unit (ALU) 210 is configured to operate upon eight-bit binary numbers. The data output of the arithmetic logic unit (ALU) 210 is coupled to an accumulator register (ACC) 290, and to a random access memory (RAM) 270. In addition the exemplary embodiment contains an address arithmetic unit (AAU) 215 having a first data input, a second data input, and a data output. In the exemplary embodiment, the address arithmetic unit (AAU) 215 is configured to operate upon sixteen-bit binary numbers. The data output of the address arithmetic unit (AAU) 215 is coupled to a program counter (PC) 220.

The random access memory (RAM) 270 is organized as 256×8 bits, for a total storage capacity of 256 bytes. The program counter (PC) 220 is further coupled to a read-only memory (ROM) 230 and to the first data input of the address arithmetic unit (215). The read-only memory (ROM) 230 is used to store the CPU program (i.e. the sequence of instructions to be executed by the CPU). In a specific exemplary embodiment, a program based on the MCS-51 instruction set is resident in the read-only memory (ROM) 230. An address value stored in the program counter (PC) 220 is used to select a specific instruction in the read-only memory (ROM) 230 to be passed to an instruction register (IR) 240. The instruction register (IR) 240 provides temporary storage to an instruction prior to passing the instruction to an instruction decoder 250. The instruction decoder 250 is coupled to the second data input of the address arithmetic unit (AAU) 215, and to the random access memory (RAM) 270. A function of the instruction decoder 250 is to recognize the arithmetic/logic operations required by an instruction and to pass the necessary data to the arithmetic logic unit (ALU). An additional function of the instruction decoder 250 is to cause the address arithmetic unit (AAU) 215 to increment the program counter (PC) 220 when required.

The random access memory (RAM) 270 is further coupled to a RAM address register (AR) 260. A RAM/ALU link 280 couples the random access memory (RAM) 270 to the second data input of the arithmetic logic unit (ALU) 210. The first data input of the arithmetic logic unit (ALU) 210 is coupled to the accumulator register (ACC) 290. In a specific exemplary embodiment of the present invention, the RAM/ALU link 280 provides an eight-bit dedicated data path to convey data from the random access memory (RAM) 270, that is, data from a read operation, to the arithmetic logic unit (ALU) 210. Microcontrollers known in the prior art which utilize the MCS-51 instruction set typically employ a shared internal bus requiring the RAM to drive data onto the bus with subsequent storage in a temporary register. The implementation of the RAM/ALU link 280 as a dedicated data path provides a significant improvement in the performance of Central processing unit (CPU) pipeline architecture portion 200.

Skilled artisans will recognize that data signal path directions are indicated by arrows in FIG. 2. Furthermore, it is to be appreciated that additional logic blocks, not shown in FIG. 2 and the figures infra, may exist and be coupled to the illustrated blocks, in order to provide the full capability of executing the MCS-51 instruction set. Those skilled in the art will appreciate that only those blocks necessary to the practice of the present invention are shown, so as to avoid obscuring the relevant elements.

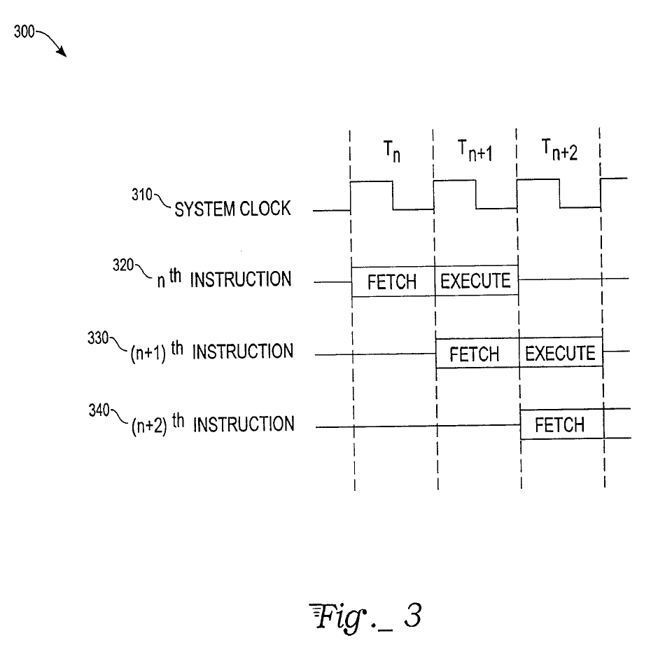

Attention is now directed to FIG. 3, a first exemplary timing diagram 300 for instruction pipelining with single-byte instructions according to the present invention. The first exemplary timing diagram 300 comprises a first example system clock waveform 310, an n^{th} instruction activity diagram 320, an (n+1)^{th} instruction activity diagram 330, and an (n+2)^{th} instruction activity diagram 340. Vertical dotted lines in FIG. 3, and in figures referenced infra containing timing diagrams, separate intervals of the system clock. The vertical dotted lines coincide with positive edge transitions of the system clock.

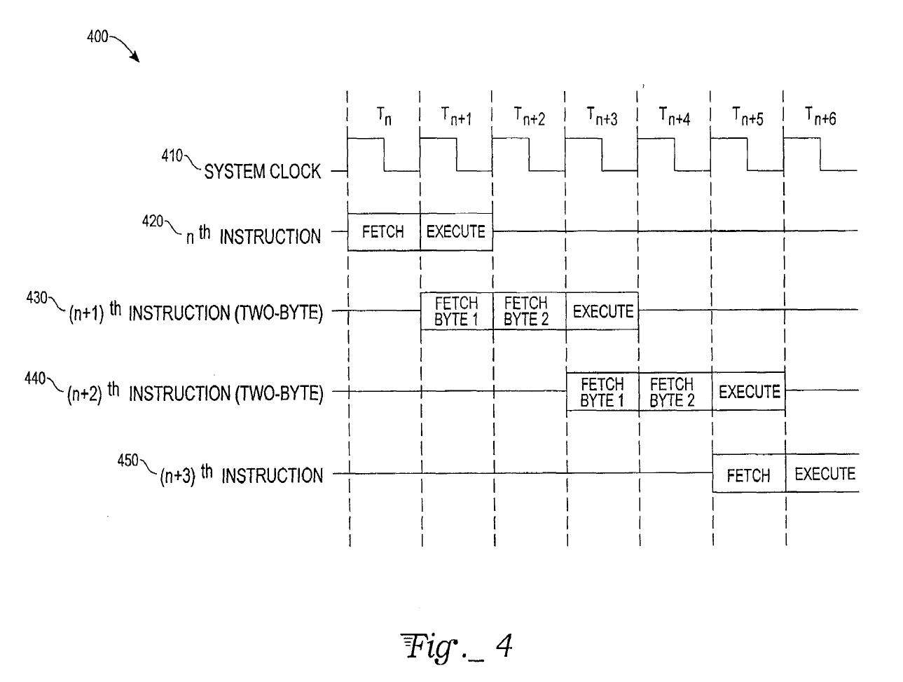

Continued reference to FIG. 3 indicates that during a system clock interval Tₙ, the n^{th} instruction undergoes a fetch operation. At subsequent system clock interval Tₙ₊₁, the n^{th} instruction executes. Simultaneously during the system clock interval Tₙ₊₁, the (n+1)^{th} instruction undergoes a fetch operation. During subsequent system clock interval Tₙ₊₂, the n^{th} instruction has completed execution. The (n+1)^{th} instruction executes and the (n+2)^{th} instruction undergoes a fetch operation. The concurrency between instruction fetch and instruction execution improves an overall computational performance of the CPU and is known by skilled artisans as a two-stage pipeline. The operational characteristics of the two-stage pipeline when executing a combination of single-byte and two-byte instructions are introduced with reference to FIG. 4, a second exemplary timing diagram 400 for instruction pipelining with single-byte and two-byte instructions according to the present invention. The second exemplary timing diagram 400 comprises second example system clock waveform 410, an n^{th} instruction activity diagram 420, an (n+1)^{th} two-byte instruction activity diagram 430, an (n+2)^{th} two-byte instruction activity diagram 440, and an (n+3)^{th} instruction activity diagram 450. Reference to the figure shows that during a system clock interval Tₙ, the n^{t}h instruction undergoes a fetch operation. At subsequent system clock interval Tₙ₊₁, the n^{th} instruction executed. Simultaneously during the system clock interval Tₙ₊₁, a first instruction byte of the (n+1)^{th} two-byte instruction undergoes a fetch operation. During subsequent system clock interval Tₙ₊₂, the n^{th} instruction has completed execution, and the second instruction byte of the (n+1)^{th} two-byte instruction undergoes a fetch operation. During system clock interval Tₙ₊₃, the (n+1)^{th} two-byte instruction executes, and first instruction byte of the (n+2)^{th} two-byte instruction undergoes a fetch operation. During system clock interval Tₙ₊₄, the second instruction byte of the (n+2)^{th} two-byte instruction undergoes a fetch operation. During system clock interval Tₙ₊₅, the (n+2)^{th} two-byte instruction executes, and the (n+3)^{th} instruction undergoes a fetch operation.

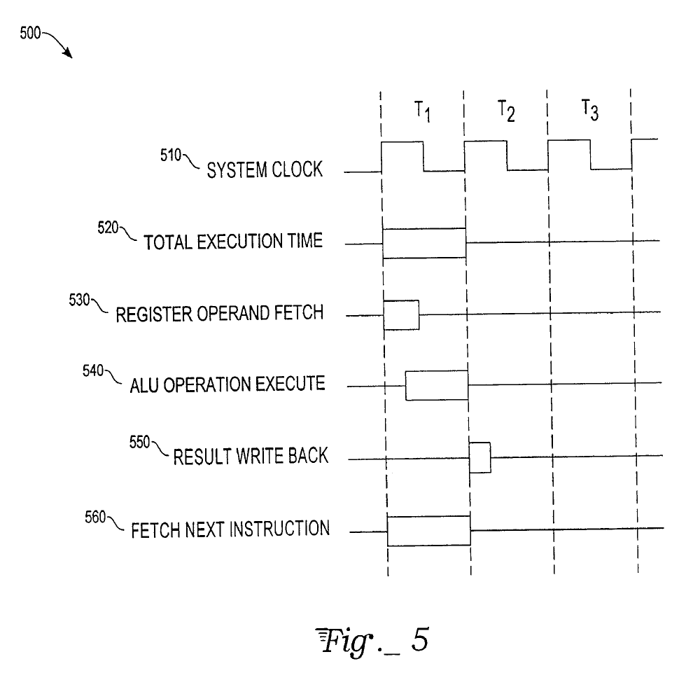

Attention is now directed to FIG. 5, a diagram of the activity within the arithmetic logic unit (ALU) 210 (FIG. 2) when executing a single-cycle instruction in accordance with an exemplary embodiment of the present invention. Single-cycle ALU operation diagram 500 comprises a single-cycle example system clock waveform 510, a single-cycle total execution time activity diagram 520, a single-cycle register operand fetch activity diagram 530, a single-cycle ALU operation execution activity diagram 540, single-cycle result write back activity diagram 550, and a single-cycle fetch next instruction activity diagram 560. Multiple events occur within a system clock interval T₁, which corresponds to the total execution time for a single-cycle instruction. Specifically, a fetch next instruction operation spans the entire system clock interval T₁. A register operand fetch and an ALU operation execute; each are active for only a portion of the system clock interval T₁. Further inspection of the figure indicates that a portion of the ALU operation execute occurs concurrently with the register operand fetch operation. Additionally, the result write back operation occurs at the beginning of the next system clock interval T₂. The delay of the result write back operation will be explained infra.

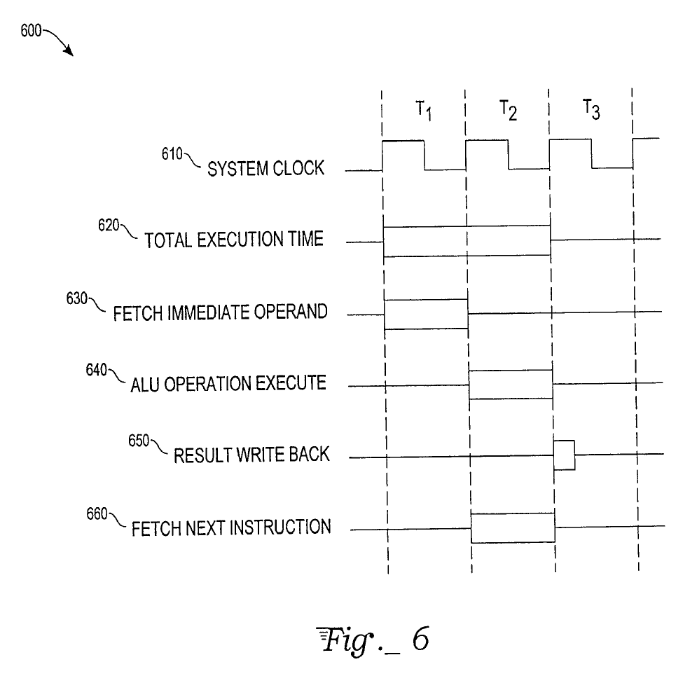

Attention is now directed to FIG. 6, a diagram of the activity within the arithmetic logic unit (ALU) 210 when executing a two-cycle instruction in accordance with an exemplary embodiment of the present invention. Two-cycle ALU operation diagram 600 comprises a two-cycle example system clock waveform 610, a two-cycle total execution time activity diagram 620, a two-cycle fetch immediate operand diagram 630, a two-cycle ALU operation execution activity diagram 640, a two-cycle result write back activity diagram 650, and a two-cycle fetch next instruction activity diagram 660. Events occur within the time span of a system clock interval T₁ and a system clock interval T₂, which in combination corresponds to the total execution time for a two-cycle instruction. A fetch immediate operand instruction executes during the system clock interval T₁ and concludes at the rising clock edge of the two-cycle example system clock waveform 610 separating the system clock interval T₁ and the system clock interval T₂. An ALU operation execute and a fetch next instruction operation initiate at the beginning of the system clock interval T₂. The ALU operation execute concludes at a falling edge of the two-cycle example system clock waveform 610, at the approximate middle of the system clock interval T₂. A result write back operation begins at the rising edge of the two-cycle example system clock waveform 610, at the beginning of the system clock interval T₃. The fetch next instruction operation concludes at the rising clock edge of the two-cycle example system clock waveform 610 separating the system clock interval T₂ and the system clock interval T₃.

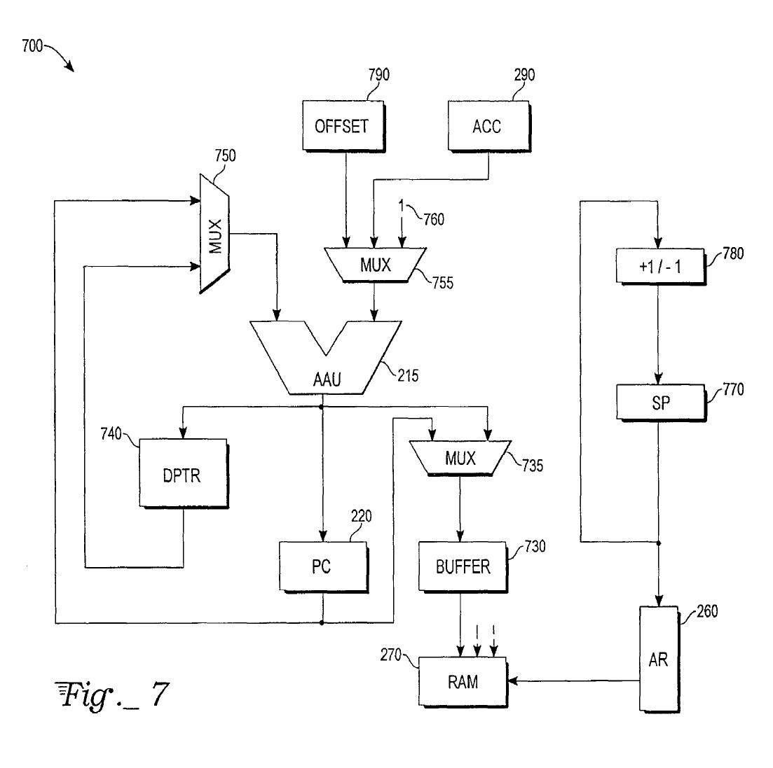

Attention is now directed to FIG. 7, a CPU address architecture block diagram 700 comprising the address arithmetic unit (AAU) 215, the program counter 220, an address buffer 730, a first multiplexer 735, a data pointer register 740, a second multiplexer 750, a third multiplexer 755, a stack pointer 770, a stack pointer increment/decrement unit 780, and an offset register 790. Data paths within the CPU address architecture block diagram 700 are indicated by lines, and directions of data flow are further indicated by arrowheads.

The second multiplexer 750 is coupled to the program counter (PC) 220, to the data pointer register 740, and to the first data input of the address arithmetic unit (AAU) 215. The multiplexer 750 selects one of an address value contained in the program counter 220 and an address value contained in the data pointer register 740 for operation by the address arithmetic unit (AAU) 215. The third multiplexer 755 is coupled to the accumulator register (ACC) 290, to a constant offset value 760, to the offset register 790, and to the second data input of the address arithmetic unit (AAU) 215. The third multiplexer 755 selects one of an address offset value contained in the offset register 790, an address offset value contained in the accumulator register (ACC) 290, and the constant offset value 760 for operation by the address arithmetic unit (AAU) 215. In a specific exemplary embodiment, the constant offset value 760 is maintained at a value of one (“1”), so that the address arithmetic unit (AAU) 215 is induced to increment an instruction address value to point to a subsequent address value.

The address arithmetic unit (AAU) 215 operates on 16-bit binary numbers with a capability of a full adder. The program counter (PC) 220, the address buffer 730, and the data pointer register 740 are each sixteen-bit registers. Microcontrollers known in the prior art which utilize the MCS-51 instruction set typically employ an 8-bit ALU to increment a data pointer register. The prior art data pointer register is typically a 16-bit register. As a result, multiple operations are required in the prior art to perform the increment operation: First, a low-byte portion of an address held by the data pointer is loaded into the ALU. An increment of one is added to the address, and the result is written back to the low byte of the data pointer. Next, a high-byte portion of the address held by the data pointer is loaded into the ALU and a carry value from the low-byte increment operation is added. The result is written back to the high byte of the data pointer. The 16-bit arithmetic capability of the address arithmetic unit (AAU) 215 of the present invention enables the data pointer register 740 to be updated with a single operation. The single operation update capability improves system operation speed and supports the instruction pipelining operations explained supra.

The program counter (PC) 220 is updated with every instruction execution. The instruction pointed to by the program counter (PC) 220 is one instruction ahead of the instruction being executed. Keeping the address in the program counter (PC) 220 one instruction ahead of the instruction being executed provides a means of maintaining the instruction pipeline. It will be appreciated by those skilled in the art that the program counter (PC) 220 update occurs with sufficient rapidity to remain ahead of the current instruction. Since the present invention provides execution of instructions as quickly as a single system clock cycle, the program counter (PC) 220 ought to be capable of being updated in a single system clock cycle as well. Microcontrollers known in the prior art which utilize the MCS-51 instruction set typically have a dedicated incrementer for the program counter (PC) 220 but employ an 8-bit ALU to compute relative branch addresses by adding an offset to the program counter (PC) 220. The use of an 8-bit ALU to compute the next program counter value for program branches requires multiple clock cycles, for reasons explained supra in association with the discussion of the data pointer register 740. The 16-bit arithmetic capability of the address arithmetic unit (AAU) 215 and the connection to the offset register 790 and the accumulator register (ACC) 290 through the third multiplexer 755 constitute improvements over the prior art and enable the program counter (PC) 220 updates to keep pace with the instruction execution pipeline.

The address buffer 730 provides a means to handle interrupts and subroutine calls without disrupting increment operations of the program counter (PC) 220. The address buffer 730 is coupled to the first multiplexer 735 which in turn is coupled to the program counter (PC) 220 and the data output of the address arithmetic unit (AAU) 215. The operation and relationship of the program counter (PC) 220 and the address buffer 730 will be explained in greater detail, infra.

The stack pointer 770 references a portion of the random access memory (RAM) 270 (FIG. 2) used as a memory stack providing access to variables that need to be accessed frequently or at high speed. An input of the stack pointer increment/decrement unit 780 is coupled to an output of the stack pointer 770. An output of the stack pointer increment/decrement unit 780 is coupled to an input of the stack pointer 770. In a specific exemplary embodiment, the stack pointer 770 is an 8-bit register. Microcontrollers known in the prior art operating with the MCS-51 instruction set utilize a single 8-bit ALU for executing arithmetic and logic instructions and for incrementing/decrementing a stack pointer register. The pipeline architecture of the present invention does not permit sufficient time for the arithmetic logic unit (ALU) 210 to increment/decrement a stack pointer. In order to provide increment and decrement operations to the stack pointer 770, the stack pointer increment/decrement unit 780 provides a dedicated means for modifying the address pointed to by the stack pointer 770, without an unnecessary reliance upon the capability of the arithmetic logic unit (ALU) 210, providing another improvement over the prior art.

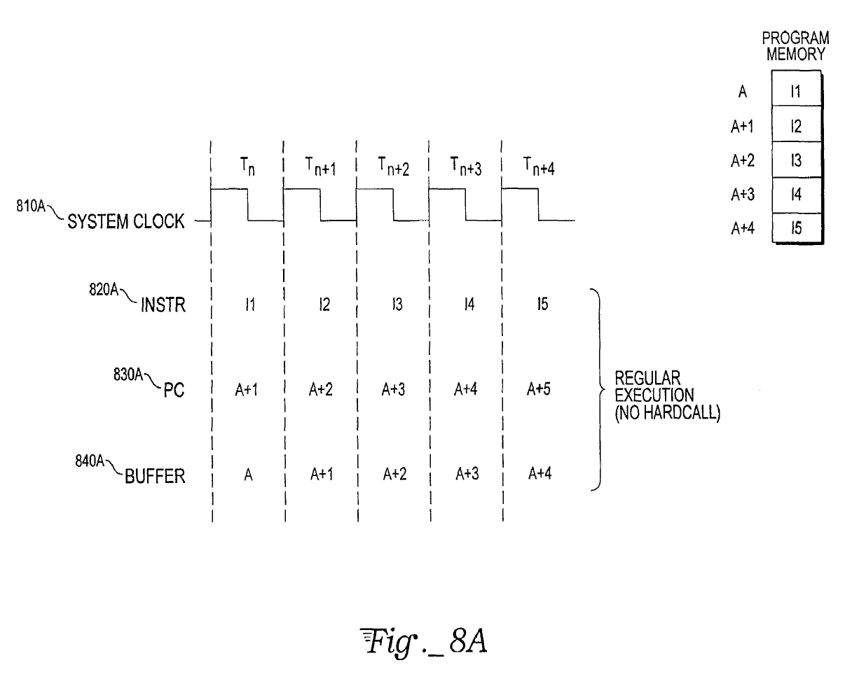

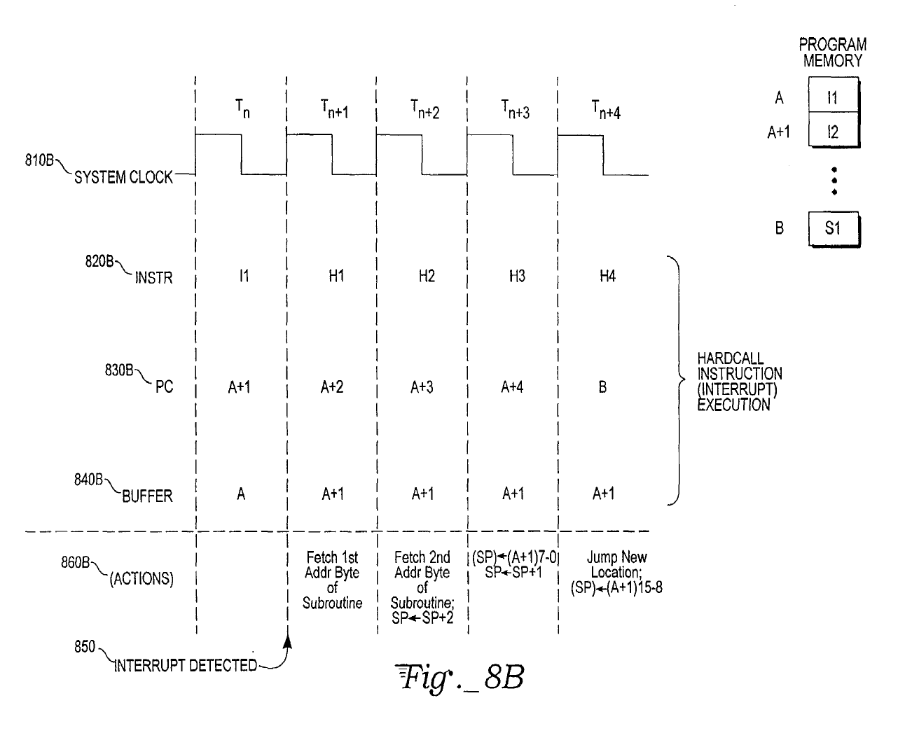

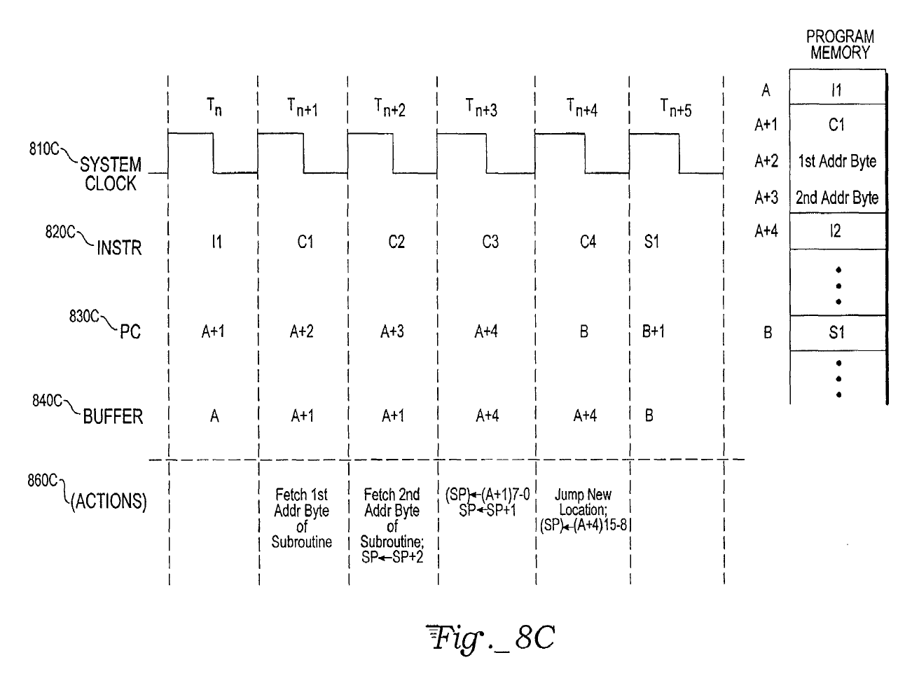

Usage of the program counter (PC) 220 and the address buffer 730 will now be explained with reference to FIG. 8A, FIG. 8B, and FIG. 8C. With reference to FIG. 8A, an illustration of address buffer utilization in accordance with an exemplary embodiment of the present invention during regular instruction execution comprises buffer usage example system clock waveform 810A, current instruction list 820A, a program counter (PC) 220 contents list 830A, and an address buffer 730 contents list 840A. At a system clock cycle interval Tₙ, reference to the current instruction list 820A shows that an instruction I1 is executing. During the system clock interval Tₙ, an address value A+1, representing the address of next instruction I2, is present in the program counter (PC) 220. Similarly, during the system clock interval Tₙ, the address value A, representing the address of the current instruction I1, is present in the address buffer 730.

At a system clock cycle Tₙ₊₁, reference to the current instruction list 820A shows that the instruction I2, pointed to by the program counter (PC) 220 during the previous system clock interval Tₙ, is now executing. During the system clock interval Tₙ₊₁, an address value A+2, representing the address of next instruction I3, is present in the program counter (PC) 220 and the previous address value A+1 is present in the address buffer 730. The progression of instruction execution and address increment operation continues in the same fashion as described supra, during regular instruction execution, that is, execution of instructions without a software or hardware interrupt, (also known to skilled artisans as a hardcall). During regular instruction execution, the program counter (PC) 220 provides the instruction address, and the address buffer 730 is not utilized to maintain the instruction pipeline.

With reference to FIG. 8B, an illustration of address buffer utilization in accordance with an exemplary embodiment of the present invention during an interrupt execution comprises buffer usage example system clock waveform 810B, current instruction list 820B, a program counter (PC) 220 contents list 830B, an address buffer 730 contents list 840B, an interrupt detect event 850, and an actions summary 860B. At a system clock interval Tₙ, reference to the current instruction list 820B shows that an instruction I1 executes. During the system clock interval Tₙ, an address value A+1, representing the address of an I2 instruction, is present in the program counter (PC) 220. Similarly, during the system clock interval Tₙ, the address value A, representing the address of the current instruction I1, is present in the address buffer 730. The I2 instruction represents the next instruction in the series to be executed in the absence of an interrupt event, i.e., during normal program execution.

At a rising edge of the buffer usage example system clock waveform 810B corresponding to the end of the system clock interval Tₙ, the interrupt detect event 850 occurs, indicating the beginning of a hardware (hardcall) interrupt. At the same rising edge the previous value of the program counter (PC) 220 is transferred to the address buffer 730 so that during a system clock interval Tₙ₊₁ the address buffer 730 contains the address value A+1, representing the address of the instruction I2. During a system clock interval Tₙ₊₁ an instruction H1, representing the first cycle of the hardcall instruction, executes, as shown by the current instruction list 820B. The first hardcall instruction differs from the instruction I2 which otherwise executes in the absence of the interrupt detect event 850. The actions summary 860B provides additional detail of events occurring in the CPU during the system clock interval Tₙ₊₁: A first address byte of the interrupt subroutine is loaded.

Additional aspects of the system clock interval Tₙ₊₁ will now be highlighted: The program counter (PC) 220 contains an address A+2, representing the address of an instruction 13, which normally follows the instruction I2. The address buffer 730 contains the address A+1, as shown by the address buffer 730 contents list 840B. Thus, the address buffer 730 retains the address of the instruction I2, which is needed to resume normal program execution at the conclusion of the interrupt event.

During a system clock interval Tn+2 subsequent to the system clock interval Tₙ₊₁, an instruction H2, representing the second cycle of the hardcall instruction, executes, as shown by the current instruction list 820B. The program counter (PC) 220 continues to be incremented by the address arithmetic unit (AAU) 215 during each system clock cycle; it therefore contains an address A+3 during the system clock interval Tn+2. However, the address buffer 730 retains the address A+1, which is needed to resume normal program execution at the conclusion of the interrupt event. The actions summary 860B provides additional detail of events occurring in the CPU during the system clock interval Tn+2: A second address byte of the interrupt subroutine is loaded and the stack pointer 770 is incremented:

SP←SP+1

During a system clock interval Tₙ₊₃ subsequent to the system clock interval Tₙ₊₂, an instruction H3, representing the third cycle of the hardcall instruction, executes, as shown by the current instruction list 820B. The program counter (PC) 220 continues to be incremented by the address arithmetic unit (AAU) 215 during each system clock cycle; it therefore contains an address A+4 during the system clock interval Tₙ₊₃. However, the address buffer 730 retains the address A+1, which is needed to resume normal program execution at the conclusion of the interrupt event. The actions summary 860B provides additional detail of events occurring in the CPU during the system clock interval Tₙ₊₃: In particular, the stack pointer 770 is incremented:

SP←SP+1

and a low-byte portion of the address buffer is loaded into the current RAM location referenced (pointed to) by the stack pointer (prior to the increment):

(SP)←BUFFER:7−0

where the notation (SP) indicates the RAM address referenced by the stack pointer 770 and BUFFER:7−0 represents the eight least-significant bits (low-byte portion) of the address buffer 730 which contains address A+1. Note that during system clock interval Tₙ₊₃ both the stack pointer increment and the push of the buffer onto RAM occur in parallel, i.e. the increment of SP does not affect the address used for the push.

During a system clock interval Tₙ₊₄ subsequent to the system clock interval Tₙ₊₃, an instruction H4, representing the fourth cycle of the hardcall instruction, executes, as shown by the current instruction list 820B. The program counter (PC) 220 now contains an address B, representing a first instruction address of the interrupt service routine. The address buffer 730 retains the address A+1, which is needed to resume normal program execution at the conclusion of the interrupt event. The actions summary 860B provides additional detail of events occurring in the CPU during the system clock interval Tₙ₊₄: A jump to a new program location (associated with the address B) occurs, and a high-byte portion of the address buffer is loaded into the current RAM location referenced (pointed to) by the stack pointer 770:

(SP)←BUFFER:15−8

where the notation (SP) indicates the RAM address referenced by the stack pointer 770 and BUFFER:15−8 represents the eight most-significant bits (high-byte portion) of the address buffer 730 which contains address A+1. After the high-byte load operation, both the low-byte portion and the high-byte portion of the address A+1 are loaded into the stack memory and are available to provide the CPU with the address A+1 when it is needed upon return from the execution of the interrupt.

With reference to FIG. 8C, an illustration of address buffer utilization in accordance with an exemplary embodiment of the present invention during a software subroutine call execution comprises buffer usage example system clock waveform 810C, current instruction list 820C, a program counter (PC) 220 contents list 830C, an address buffer 730 contents list 840C, and an actions summary 860C. At a system clock interval Tₙ, reference to the current instruction list 820C shows that an instruction I1 executes. During the system clock interval Tₙ, an address value A+1, representing the address of a call instruction C1, is present in the program counter (PC) 220. Similarly, during the system clock interval Tₙ, the address value A, representing the address of the current instruction I1, is present in the address buffer 730.

At a rising edge of the buffer usage example system clock waveform 810C corresponding to the end of the system clock interval Tₙ, the previous value of the program counter (PC) 220 is transferred to the address buffer 730 so that during a system clock interval Tₙ₊₁ the address buffer 730 contains the address value A+1, representing the address of an instruction C1. During a system clock interval Tₙ₊₁ an instruction C1, representing the first cycle of the call instruction, executes, as shown by the current instruction list 820C. The actions summary 860C provides additional detail of events occurring in the CPU during the system clock interval Tₙ₊₁: A first address byte of the software subroutine is loaded.

Additional aspects of the system clock interval Tₙ₊₁ will now be highlighted: The program counter (PC) 220 contains an address A+2, representing the address of the first address byte of the called subroutine, which normally follows the instruction C1. The address buffer 730 contains the address A+1, as shown by the buffer address contents list 840C. Thus, the address buffer 730 retains the address of the current instruction C1.

During a system clock interval Tₙ₊₂ subsequent to the system clock interval Tₙ₊₁, an instruction C2, representing the second cycle of the call instruction, executes as shown by the current instruction list 820C. The program counter (PC) 220 continues to be incremented by the address arithmetic unit (AAU) 215 during each system clock cycle; it therefore contains an address A+3 during the system clock interval Tₙ₊₂. However, the address buffer 730 retains the address A+1. The actions summary 860C provides additional detail of events occurring in the CPU during the system clock interval Tₙ₊₂: A second address byte of the software subroutine is loaded and the stack pointer 770 is incremented:

SP←SP+1

At a rising edge of the system clock waveform 810C corresponding to the end of the system clock interval Tₙ₊₂, the increment value of the program counter (PC) 220 coming from the address arithmetic unit (AAU) 215 is transferred to the address buffer 730 so that during a system clock interval Tₙ₊₃ the address buffer 730 contains the address value A+4, representing the address of an instruction I2. I2 is the instruction after C1 which should be executed upon a return from the subroutine. During a system clock interval Tₙ₊₃ subsequent to the system clock interval Tₙ₊₂, an instruction C3, representing the third cycle of the call instruction, executes, as shown by the current instruction list 820C. The program counter (PC) 220 continues to be incremented by the address arithmetic unit (AAU) 215 during each system clock cycle; it therefore contains an address A+4 during the system clock interval Tₙ₊₃. Also, the address buffer 730 contains the address A+4, which is needed to resume normal program execution at the conclusion of the subroutine. The actions summary 860C provides additional detail of events occurring in the CPU during the system clock interval Tₙ₊₃: In particular, the stack pointer 770 is incremented:

SP←SP+1

and a low-byte portion of the address buffer is loaded into the current RAM location referenced (pointed to) by the stack pointer (prior to the increment):

(SP)←BUFFER:7−0

where the notation (SP) indicates the RAM address referenced by the stack pointer 770 and BUFFER:7−0 represents the eight least-significant bits (low-byte portion) of the address buffer 730 which contains address A+4. Note that during the system clock interval Tₙ₊₃ both the stack pointer increment and the push of the buffer onto RAM occur in parallel, i.e. the increment of SP does not affect the address used for the push.

During a system clock interval Tₙ₊₄ subsequent to the system clock interval Tₙ₊₃, an instruction C4, representing the fourth cycle of the hardcall instruction, executes, as shown by the current instruction list 820C. The program counter (PC) 220 now contains an address B, representing a first instruction address of the software subroutine. The address buffer 730 retains the address A+4, which is needed to resume normal program execution at the conclusion of the subroutine. The actions summary 860C provides additional detail of events occurring in the CPU during the system clock interval Tₙ₊₄: A jump to a new program location (associated with the address B) occurs, and a high-byte portion of the address buffer is loaded into the current RAM location referenced (pointed to) by the stack pointer 770:

(SP)←BUFFER:15−8

where the notation (SP) indicates the RAM address referenced by the stack pointer 770 and BUFFER:15−8 represents the eight most-significant bits (high-byte portion} of the address buffer 730 which contains address A+4. After the high-byte load operation, both the low-byte portion and the high-byte portion of the address A+4 are loaded into the stack memory and are available to provide the CPU with the address A+4 when it is needed upon return from the execution of the subroutine.

By reference to the explanation of FIG. 8A, FIG. 8B, and FIG. 8C, supra, the relationship between the program counter (PC) 220 and the address buffer 730 becomes evident: Specifically, during normal program execution the program counter (PC) 220 points to the next instruction address and the address buffer 730 points to the current address value, with the program counter (PC) 220 incremented during a system clock cycle. The address buffer 730 updates only at the conclusion of an instruction execution when it receives the current value of the program counter (PC) 220 through the first multiplexer 735. The program counter (PC) 220 continually updates, and the update may occur during an instruction. Thus, the program counter (PC) 220 may point to a different address from the address pointed to by the address buffer 730 during a portion of an instruction execution cycle. In this manner, the increment process for the program counter (PC) 220 may continue at a rate which enables it to match the execution speed of the instruction pipeline. If an interrupt occurs, the program counter (PC) 220 continues to update, but the return address from the interrupt may be trapped by the address buffer 730. A decision to execute an interrupt is therefore taken in parallel with the increment process of the program counter (PC) 220. This represents an improvement over the prior art, which typically requires additional logic to stop the increment process for a program counter and to decrement the program counter in order to restore the return address needed by the interrupt sequence.

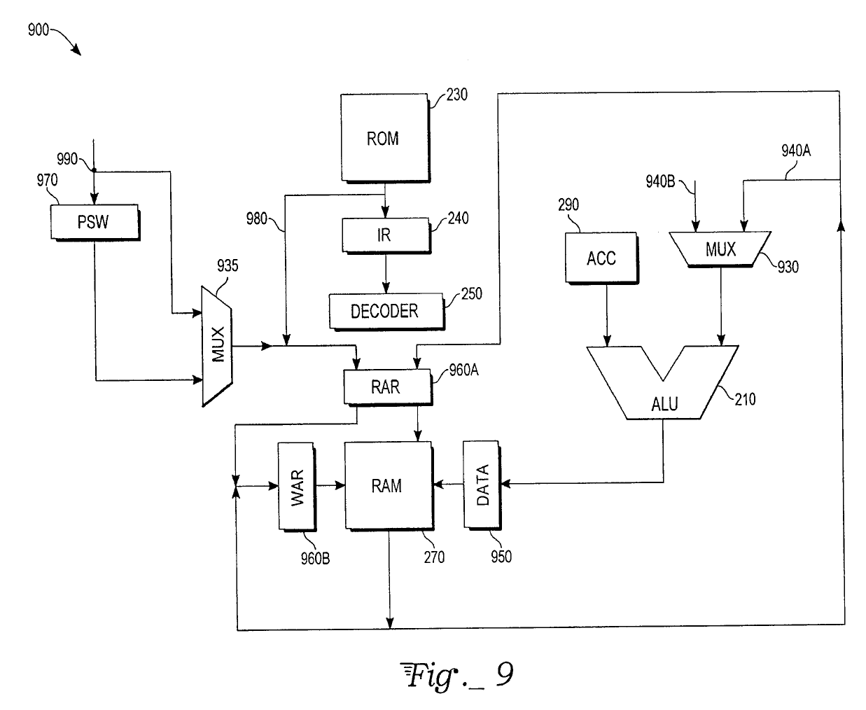

Attention is now directed to FIG. 9, an exemplary instruction pre-decode and RAM addressing block diagram 900 comprising the accumulator register (ACC) 290 coupled to the first input of the arithmetic logic unit (ALU) 210. A multiplexer 930 selects one of a RAM output path 940A and an alternate multiplexer input 940B for coupling to the second input of the arithmetic logic unit (ALU) 210. An output of the arithmetic logic unit (ALU) 210 is coupled to a data register 950. The data register 950 is further coupled to the random access memory (RAM) 270. An output from the random access memory (RAM) 270 is coupled to the RAM output path 940A, to a RAM read address register (RAR) 960A, and to a RAM write address register (WAR) 960B. The RAM read address register (RAR) 960A is coupled to the random access memory (RAM) 270 and to the RAM write address register (WAR) 960B, which is further coupled to the random access memory (RAM) 270. A program status word (PSW) register 970 and its input 990 are coupled to an RAR multiplexer 935 which in turn is coupled to the RAM read address register (RAR) 960A. An output from the read-only memory (ROM) 230 is coupled to the instruction register (IR) 240. The instruction register (IR) 240 is further coupled to the instruction decoder 250. An address pre-decode path 980 couples the output of the read-only memory (ROM) 230 to the RAM read address register (RAR) 960A.

The combination of the RAM output path 940A, the multiplexer 930 and the arithmetic logic unit (ALU) 210 represent an improvement over the prior art. Skilled artisans will appreciate that a temporary storage register is typically implemented between the multiplexer 930 and the arithmetic logic unit (ALU) 210 to support an internal bus architecture. As a result, the prior art process of transferring data from a random access memory to an ALU requires an intermediate step of storing the data in the temporary storage register before the data are passed to the ALU. The intermediate step of storing data in the temporary register requires a minimum of one system clock cycle added as overhead to the processing time. The RAM output path 940A of the present invention provides a means of passing data directly from the random access memory (RAM) 270 to the arithmetic logic unit (ALU) 210, enabling processing to occur in a single system clock cycle, with a result captured by the data register 950 in the same single system clock cycle.

An additional improvement over the prior art is provided by the address pre-decode path 980, which will now be explained. Certain instructions, specifically register operations, require rapid execution with minimum clock cycles to enable the speed and performance objectives which have been described supra. For example, the present invention employs the address pre-decode path 980 to enable rapid execution of the MCS-51 instructions:

| Instruction | Operation | Opcode |
|---|---|---|
| INC Rn | Rn ← Rn + 1 | 0000 1rrr |
| INC @Ri | (Ri) ← (Ri) + 1 | 0000 011i |
| MOV @Ri, ACC | (Ri) ← ACC | 1111 011i |

where the instruction INC Rn is a register increment, and the variable n can correspond to values of 0-7. The portion of the opcode designated rrr represents the binary encoding corresponding to variable n. The instruction INC @Ri is an indirect register increment, with variable i taking possible values of 0 and 1. The MOV @Ri, ACC instruction moves the accumulator contents into the address pointed to by register Ri, with variable i taking possible values of 0 and 1.

All instructions read from the read-only memory (ROM) 230 are passed by the address pre-decode path 980 to the RAM read address register (RAR) 960A, which begins a speculative decode of the instruction based upon the least significant 4 bits of the instruction. The RAM read address register (RAR) 960A contains a small amount of decode logic, created by methods well known to those skilled in the art, to examine bits 3:0 of the opcode. If bit 3 is a one, the decode logic assumes an increment operation with register Rn, with bits 2:0 specifying the value of the register. If bits 3:1 of the opcode equal the binary value 011, a register indirect increment is assumed, with bit 0 specifying the register.

Every opcode is speculatively evaluated according to the method described supra and the RAM read address register (RAR) 960A is loaded accordingly. However, some opcodes do not require an immediate read from a register. To save power, a means is required to permit only necessary register operations to read the RAM using the pre-decoded address. The determination as to whether an opcode actually involves a register read operation is made by providing an additional pre-decode operation in the instruction register (IR) 240. The instruction register (IR) 240 contains additional logic to differentiate a RAM read operation from a RAM write operation. The additional logic prevents the RAM read address register (RAR) 960A from initiating a random access memory (RAM) 270 read operation unless the opcode actually requires the read operation. Avoiding the initiation of an unnecessary read operation prevents an energy-wasting step of powering up sense amplifiers and related circuits (not shown) in the random access memory (RAM) 270.

As an additional consideration, the 8051 microcontroller architecture provides four register banks, each having eight registers. A means is necessary to provide the RAM address register (AR) 260 (FIG. 2) with knowledge as to which of four possible register banks contains the register target of an instruction. Register bank information is provided by the program status word (PSW) register 970 to the RAM read address register (RAR) 960A. Specifically, bits 4:3 of a program status word, stored in the program status word (PSW) register 970 are concatenated with bits 3:0 from the opcode to provide the RAM read address register (RAR) 960A with an address target in the random access memory (RAM) 270. To prevent pipeline stalls in the case where a write to the program status word (PSW) register 970 is followed by a register read which utilizes the address pre-decode path 980, the RAR multiplexer 935 is provided to forward the new value of the PSW from the PSW input 990 to the address pre-decode path 980, bypassing the old value in the program status word (PSW) register 970.

In the exemplary embodiment of the present invention, the registers shown in FIG. 9, specifically the instruction register 240, the instruction decoder 250, the accumulator register (ACC) 290, the data register 950, the RAM read address register (RAR) 960A, the RAM write address register (WAR) 960B, and the program status word (PSW) register 970, are implemented with master-slave positive-edge trigger flip-flops. Skilled artisans will appreciate that this method for register implementation may be employed in other circuit blocks not shown in the figure.

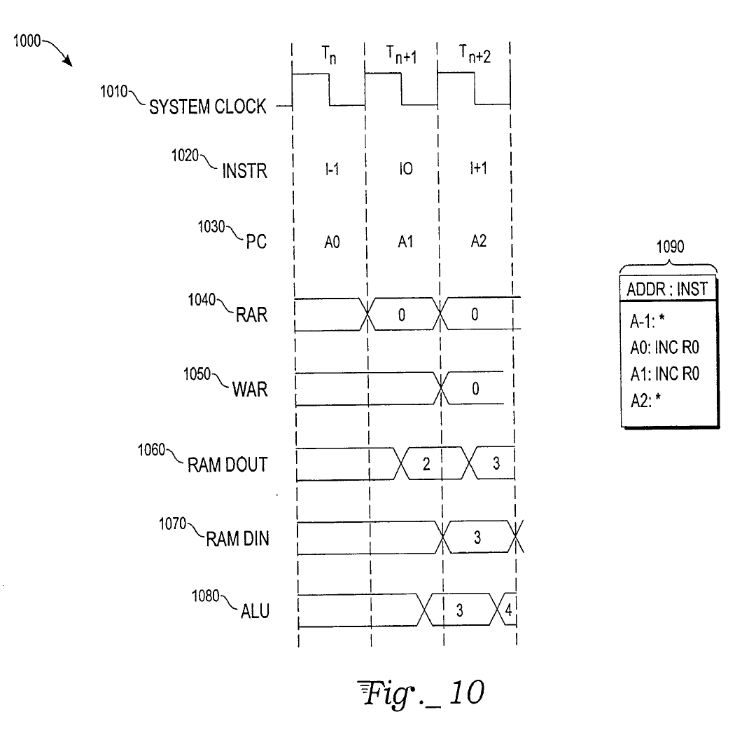

Reference is now made to FIG. 10, a register increment timing diagram 1000 in accordance with an exemplary embodiment of the present invention which comprises register increment example system clock waveform 1010, register increment example current instruction (INSTR) list 1020, register increment example program counter (PC) 220 contents list 1030, RAM read address register (RAR) 960A contents diagram 1040, RAM write address register (WAR) 960B contents diagram 1050, RAM data out (DOUT) contents diagram 1060, RAM data in (DIN) contents diagram 1070, arithmetic logic unit (ALU) 210 contents list 1080, and an instruction example summary 1090. At a system clock interval Tₙ, the system executes a generic instruction (indicated by an asterisk in the instruction example summary 1090); the generic instruction is associated with an address A−1 and is designated as I−1 by the register increment example current instruction (INSTR) list 1020. Reference to the register increment example program counter (PC) 220 contents list 1030 shows that an address A0, associated with a first register direct increment instruction (INC RO) is present in the program counter (PC) 220 during the system clock interval Tₙ, in accordance to the operation of the instruction pipeline described supra. For the purpose of the example, the initial value of register R0 is assumed to be two.

At a system clock interval Tₙ₊₁, the first register increment instruction, I0 executes. The program counter (PC) 220 contains an address A1 of the next instruction (also INC R0 for this example). The RAM read address register (RAR) 960A contains zero, shown by the RAM read address register (RAR) 960A contents diagram 1040. The value zero is the target register address, and is loaded into the RAM read address register (RAR) 960A by means of the address pre-decode path 980, avoiding the delay of progressing through the instruction decoder 250. Within the same system clock interval Tₙ₊₁, the data at the register target address (the value 2) are available at the random access memory (RAM) 270 output, indicated by the RAM data out (DOUT) contents diagram 1060. The value is incremented by the arithmetic logic unit (ALU) 210 before the conclusion of the system clock interval Tₙ₊₁, giving a value of three as indicated by the arithmetic logic unit (ALU) 210 contents list 1080. During a system clock interval Tₙ₊₂, The ALU output (the value three) is passed to the data register 950, as indicated by the RAM data in (DIN) contents diagram 1070. The RAM write address register (WAR) 960B contains an address value of zero, loaded to enable a write-back of the result from execution of the first register direct increment instruction (INC R0). A second register direct increment instruction I+1 executes, as shown by the register increment example current instruction (INSTR) list 1020. The RAM read address register (RAR) 960A contains zero, shown by the RAM read address register (RAR) 960A contents diagram 1040. Because the RAM read address register (RAR) 960A and the RAM write address register (WAR) 960B point to the same address (0), a data pass-through occurs in the random access memory (RAM) 270, causing the value three to be propagated to the RAM output with minimal delay, as shown by the RAM data out (DOUT) contents diagram 1060. The value three is incremented by the arithmetic logic unit (ALU) 210 to a value four, as shown by the arithmetic logic unit (ALU) 210 contents list 1080, with the result available before conclusion of the system clock interval Tₙ₊₂. Thus, two direct register increment operations are completed in the span of two system clock cycles. As discussed supra, a write-back of the value four completes in a subsequent system clock interval Tₙ₊₃ (not shown).

In the foregoing specification, the invention has been described with reference to specific embodiments thereof. It will, however, be evident to a skilled artisan that various modifications and changes can be made thereto without departing from the broader spirit and scope of the invention as set forth in the appended claims. For example, improvements comprised by the pipeline implementation, the dedicated stack pointer increment/decrement unit, and the application of a single 16-bit single ALU to support in combination an address buffer, a program counter, and a data pointer, are applicable to a variety of microprocessors and microcontrollers, including those which utilize instruction sets other than the MCS-51 instruction set. The specification and drawings are, accordingly, to be regarded in an illustrative rather than a restrictive sense.

What is claimed is:

1. A central processing unit (CPU), comprising:
an address arithmetic unit (AAU) having an output, the AAU to operate on address values;
an arithmetic logic unit (ALU) having an input and an output, the ALU to operate on data values and configured to perform arithmetic and logic operations to execute a program instruction;
a random access memory (RAM) having an input coupled to the ALU output, and an output coupled to the ALU input via a dedicated RAM/ALU link; and
a multiplexer operatively coupled to the dedicated RAM/ALU link to pass data directly from the RAM to the ALU via the dedicated RAM/ALU link without storing the data in a temporary storage.
